(19) United States
(12) Patent Application Publication
(10) Pub. No.: US 2004/0105651 A1
(43) Pub. Date: Jun. 3, 2004

(54) Variable optical attenuator in micro-electro-mechanical systems and method of making the same

(76) Inventors: Hawk Chen, Lujou City (TW); Hsuan-Hsi Chang, Sanchung City (TW)

Correspondence Address: PRO-TECHTOR INTERNATIONAL, 20775 Norada Court, Saratoga, CA, 95070-3018, US

(21) Appl. No.: 10/349,387

(22) Filed: Jan. 21, 2003

(30) Foreign Application Priority Data
Dec. 3, 2002 (TW) 91135124

(51) Int. Cl. G02B 6/00

(52) U.S. Cl. 385/140

(57) ABSTRACT

A variable optical attenuator in micro-electro-mechanical systems includes a moving shutter for attenuating the energy of a light entering the attenuator, a first optical fiber transversely located on one side of the moving shutter with a first inclined surface facing the shutter, and a second optical fiber transversely located on the other side of the moving shutter with a second inclined surface facing the shutter. The second optical fiber and the first optical fiber are parallel to each other with a space and a shift on the same plane.

### FIELD OF THE INVENTION

The invention relates to a variable optical attenuator (VOA), and more particularly, to a VOA having low return loss in micro-electro-mechanical systems (MEMS).

### DESCRIPTION OF THE PRIOR ART

Optical attenuators are devices for attenuating optical power in order to measure sensitivity and balance optical path power transmission in fiber optical systems. Generally, optical attenuators have characteristics as being light in weight, small in volume, easy to use, as well as having high accuracy and stability. In recent years, a variable optical attenuator (VOA) has been developed owing to the advancement of semiconductor manufacturing techniques and MEMS techniques. For example, the U.S. Pat. No. 6,275,320 B1 has disclosed a VOA. The VOA used an actuator in it to make a shutter move or incline at different angles in order to shield the optical path thereof and then to change the amount of the energy of the light outputted.

FIG. 1 shows a top view of a VOA 10 in MEMS according to the prior art. Referring to FIG. 1, two optical fibers 11 and 12 on the sides of a moving shutter 13 are disposed and located in a fiber optic locator 14, respectively. Especially, they are aligned to be in one linear line. With respect to the above, the moving shutter 13 is generally designed as having an inclined surface for decreasing the reflected part of the light waves emitted from the terminal facet 15 of the optical fiber 11. As a result, the light waves reflected back to the interior of the optical fiber 11 can be reduced. The reason for the above is that the reflected light waves may damage the phase resonant effect in the laser resonant cavity, lower the output power, increase noise, and affect the system function as a whole. Therefore, the return loss within an optical fiber is preferably less than −50 dB in designing specifications of a VOA in MEMS. However, as far as the optical fibers 11 and 12 aligned as a linear line are concerned, a reflection of the light waves may occurred at the terminal facet 15 of the optical fiber when the light waves are emitted from the optical fiber 11 to the air medium. As a result, the return loss can not be effectively lowered to −50 dB by solely the inclined surface of the moving shutter 13, and the product function would be influenced.

In addition, according to the fundamental principle of fiber optics, the light waves can be transmitted through long distances by total reflection of light within the optical fiber and a minimal transmission loss of light can be achieved at the other end of the optical fiber. FIG. 2 is a schematic view illustrating the traveling path of a light entering an optical fiber. Referring to FIG. 2, optical fiber 1 is basically consisted of dielectric materials namely core 1b and cladding 1a, wherein the refractive index n₁ of the core 1b is slightly higher than the refractive index n₂ of the cladding 1a, such that a light 3 is total reflected within the core 1b. Suppose the light 3 is transmitted within the optical fiber and the critical angle of the total reflection is θ_{c}, the principle thereof is indicated as the following equations (1) to (3):

n₁×sin θ_{c}=n₂×sin 90°=n₂ (1)

sin θ_{c}=n₂/n₁ (2)

θ_{c}=sin⁻¹(n₂/n₁) (3)

In addition, the numerical aperture (NA) represents the largest in-coming incident angle that can cause the total reflection within the core of the optical fiber when a light coupled into the optical fiber. Referring to FIG. 2, suppose θ_{A} is a largest in-coming incident angle when a light 3 coupled into the optical fiber 1, θ_{B} is an included angle between the light 3 in the core 1b and a central axis 2 of the optical fiber, and the refractive index of air n₀ equals 1, then

n₀×sin θ_{A}=n₁×sin θ_{B}=n₁×cos θ_{C} (4)

sin θ_{A}=n₁×cos θ_{C} (5)

NA=sin θ_{A}=\sqrt{n₁²−n₂²} (6)

Considering the optical fiber practical for applications, the refractive index n₁ of the core thereof is approximately 1.5 and the refractive index n₂ of the cladding is approximately 1.485; the difference between the two is rather small. When n₂/n₁=0.99, the critical angle θ_{C} is approximately 82°, the largest in-coming incident angle θ_{A} is approximately 12°, and NA=0.21. In other words, the included angle θ_{B} between the light 3 and the central axis 2 of the optical fiber is approximately 8°. Therefore, when a light is coupled into the optical fiber, the incident angle thereof has to be less than 12°. Besides, for the purpose that an internal total reflection exists, it is necessary to limit the included angle between the light and the central axis within 8° during the transmission of the light within the optical fiber. Otherwise, the light could not be transmitted within the core of the optical fiber.

### SUMMARY OF THE INVENTION

Therefore, an object of the invention is to provide a VOA in MEMS capable of reducing return loss and insertion loss.

Another object of the invention is to provide a method for making a VOA in MEMS. The method is able to effectively lower return loss and insertion loss, thereby bringing the VOA to conform to specifications of optical fiber system applications.

The VOA in MEMS according to the invention comprises a moving shutter for attenuating the energy of an optical signal entering the VOA; a first optical fiber transversely located on one side of the moving shutter with a first inclined surface facing the shutter; and a second optical fiber transversely located on the other side of the moving shutter with a second inclined surface facing the shutter. The second optical fiber and the first optical fiber are parallel to each other with a first distance in between, and the central axis of the second optical fiber shifts a second distance relative to the central axis of the first optical fiber.

In one aspect, the oblique angle of the second inclined surface is the same as the oblique angle of the first inclined surface as long as the reflection of the optical signal within the first optical fiber and the insertion loss thereof are reduced. In one embodiment, the first oblique angle is preferably 8°, which effectively decrease the reflected light.

In another aspect, an angle difference exists between the oblique angles of the first inclined surface and the second inclined surface. Especially, the angle difference has a particular range that allows it to decrease the reflection of the optical signal within the first optical fiber as well as lower the insertion loss thereof.

It shall be noted that, in the aforesaid aspects, the design of the oblique angle of the first inclined surface prohibits the reflected part of the optical signal at the first inclined surface of the first optical fiber from causing total reflection within the first optical fiber, and the second distance determines the first distance and the oblique angle of the first inclined surface.

Therefore, the VOA in MEMS according to the invention is capable of effectively reducing the return loss to under −50 dB as a main advantage, thereby elevating the product performance.

### DETAILED DESCRIPTION OF THE PREFERRED EMBODIMENTS

Descriptions shall be given below with the accompanying drawing for illustrating the VOA in MEMS according to the invention.

FIG. 3 shows a top view of a VOA in MEMS according to the present invention. Referring to FIG. 3, the VOA 100 in MEMS according to the invention comprises two optical fibers 111 and 112, and a moving shutter 113. Wherein, the two optical fibers 111 and 112 are disposed and located within a fiber optic locator 114, respectively. The fiber optic locator 114 employed in the invention may be a V-shaped groove, a planar locating groove, a planar locating bump or other devices formed by fiber optic locating methods.

It shall be noted that, first of all, the first and second fiber optic locators 114 are formed to be parallel to each other on a same plane, and are transversely located on the two sides of the moving shutter 113, respectively, such that a space L exists between terminal facets 115a and 115b of the two optical fibers 111 and 112, respectively. Secondly, a shift S exists between the two fiber optic locators 14. Thirdly, the two terminal facets 115a and 115b of the optical fibers 111 and 112 facing the moving shutter 113 are both pared to have an inclined surface with an oblique angle θ, respectively, and the terminal facets 115a and 115b are parallel to each other. Fourthly, referring to FIG. 4, because of the circumstances that the terminal facets of the optical fibers are pared as inclined surfaces, a reflected light wave 116a produced at the inclined terminal facet 115a is unable to meet the transmission mode of fiber optics, and therefore the reflected light wave 116a fails to cause total reflection within the optical fiber 111. In other words, the light wave 116a is unable to be transmitted within the core 111b of the optical fiber, and the return loss is effectively lowered. Considering the above, the aforesaid shift S exists as a result of the oblique angle θ, and detailed description shall be given below for illustrating the relationship between the shift S, space L, and oblique angle θ of a VOA in MEMS.

Referring to FIG. 5, based upon the refraction principle, a deviated angle α is produced when a light wave 117 within the optical fiber 111 travels to the terminal facet 115a with an oblique angle θ. As a result, it is necessary for the terminal facet 115b of the optical fiber 112 paralleling to the optical fiber 111 to have a same oblique angle θ and a shift S relative to the optical fiber 111, so that the optical fiber 112 is able to accept the light wave 117 passing through the terminal facet 115a. That is, the shift S may be varied according to the degree of the oblique angle θ of the optical fibers 111 and 112. The equations (7) and (8) listed below explain the relationship between the refractive index n₁ of the core of the optical fiber 111, the oblique angle θ of the terminal facet 115a, the refraction angle α of the light wave 117, the refractive index no of air, the space L and the shift S:

n₁×sin θ=n₀×sin(θ+α) (7)

S=L×tan α (8)

Therefore, it is concluded from the equations (7) and (8) that, the shift S is practically determined by the space L and the oblique angle θ while the refractive index n₁ of the core of the optical fiber 111 and the refractive index n₀ of air are known, meaning that the shift S may be adjusted according to the space L and the oblique angle θ.

In an embodiment of the invention, the terminal facets 115a and 115b of the optical fibers 111 and 112 are pared as inclined surfaces having an oblique angle of 80. In addition, the refractive index n₁ of the core (glass material) of the optical fibers 111 and 112 is 1.5 and the refractive index n₀ is 1. According to these conditions and the equations (7) and (8), the refraction angle α is calculated as approaching 4°. It is worth noticing that the reflected light wave is soon diverged with the terminal facets of the optical fibers being pared to have oblique angles between 6° and 12°, and thus the return loss is lowered. Such design of inclined surfaces not only enables the VOA in MEMS to conform to specifications of optical fiber communication applications, but also decreases the return loss within the optical fiber and lowers the insertion loss.

Summing up the above, descriptions of the preferred embodiments according to the present invention have been illustrated in detail. However, it is to be understood that the embodiments described herein are merely illustrative of the principles of the invention, namely, a wide variety of modifications thereto may be effected by persons skilled in the art without departing from the spirit and scope of the invention as defined by the appended claims.

### BRIEF DESCRIPTION OF THE DRAWINGS

FIG. 1 shows a top view of a VOA in MEMS according to the prior art.

FIG. 2 is a schematic view for illustrating the traveling path of a light entering an optical fiber.

FIG. 3 shows a top view of a VOA in MEMS according to one aspect of the invention.

FIG. 4 is a schematic view for illustrating the traveling path of a light in FIG. 3 after being reflected at the terminal facet of the optical fiber.

FIG. 5 is a schematic view for illustrating the traveling path of a light in FIG. 3 after passing through the terminal facet of the optical fiber.

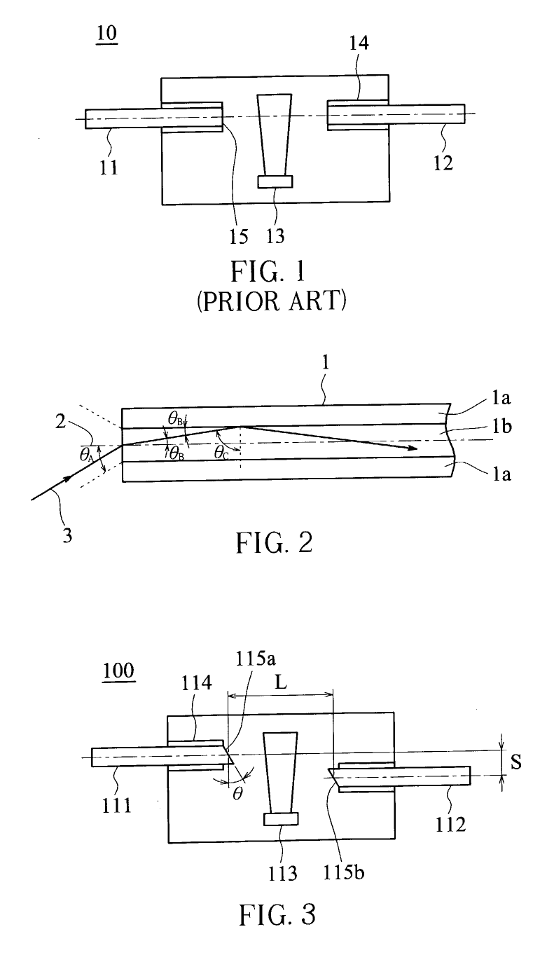

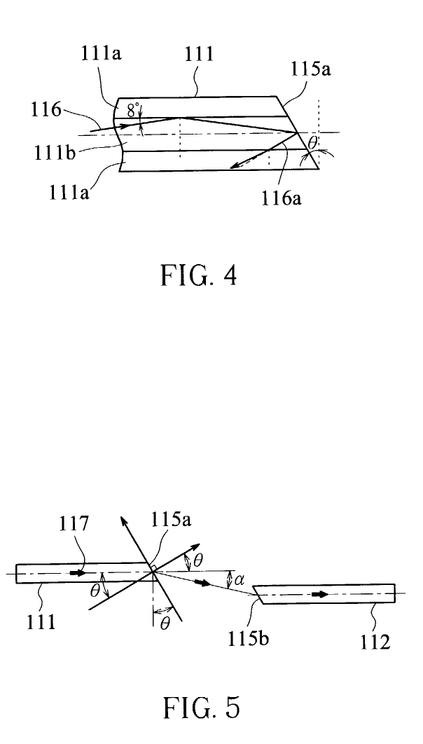

What is claimed is:

1. A variable optical attenuator (VOA) in micro-electro-mechanical systems (MEMS) comprising:
a moving shutter for attenuating the coupled energy of an optical signal;
a first optical fiber transversely located on one side of the moving shutter with a first inclined surface facing one terminal of the moving shutter; and
a second optical fiber transversely located on the other side of the moving shutter with a second inclined surface facing one terminal of the moving shutter;
wherein the second optical fiber and the first optical fiber are disposed on a same plane, the first inclined surface and the second inclined surface are parallel to each other with a distance in between, and the central axis of the second optical fiber shifts a second distance relative to the central axis of the first optical fiber.

2. The VOA in MEMS as described in claim 1, wherein the oblique angle of the first inclined surface is the same as that of the second incline angle for reducing the reflection of the optical signal within the first optical fiber and then lowering the insertion loss.

3. The VOA in MEMS as described in claim 1, wherein an angle difference exists between the first inclined angle and the second inclined angle, and the angle difference has a particular range for reducing the reflection of the optical signal within the first optical fiber and then lowering the insertion loss.

4. The VOA in MEMS as described in claim 2, wherein the design of the first inclined surface prohibits the reflected part of the optical signal at the first inclined surface of the first optical fiber from causing total reflection within the first optical fiber.

5. The VOA in MEMS as described in claim 3, wherein the design of the first inclined surface prohibits the reflected part of the optical signal at the first inclined surface of the first optical fiber from causing total reflection within the first optical fiber.

6. The VOA in MEMS as described in claim 2, wherein the second distance is determined by the first distance and the oblique angle of the first inclined surface.

7. The VOA in MEMS as described in claim 3, wherein the second distance is determined by the first distance and the oblique angle of the first inclined surface.

8. The VOA in MEMS as described in claim 1, wherein the first and second optical fibers are located within a fiber optic locator, respectively.

9. A method for making a VOA in MEMS comprising the steps of:
paring a terminal facet of a first optical fiber as a first inclined surface;
paring a terminal facet of a second optical fiber as a second inclined surface;
transversely locating the first optical fiber on one side of a moving shutter such that the terminal facet faces the moving shutter; and
transversely locating the second optical fiber on the other side of the moving shutter with a distance in between relative to the terminal facet of the first optical fiber, and the first optical fiber and the second optical fiber are disposed on a same plane with the first inclined surface and the second inclined surface parallel to each other.

10. The method for making a VOA in MEMS as described in claim 9, wherein the oblique angles of the first inclined surface and the second inclined surface are the same.

11. The method for making a VOA in MEMS as described in claim 9, wherein the oblique angles of the first inclined surface and the second inclined surface are different.

12. The method for making a VOA in MEMS as described in claim 10, wherein the central axis of the second optical fiber shifts a second distance relative to the central axis of the first optical fiber, and the second distance is determined by the first distance and the oblique angle of the first inclined surface.

13. The method for making a VOA in MEMS as described in claim 11, wherein the central axis of the second optical fiber shifts a second distance relative to the central axis of the first optical fiber, and the second distance is determined by the first distance and the oblique angle of the first inclined surface.

14. The method for making a VOA in MEMS as described in claim 10, wherein the oblique angle of the first inclined surface prohibits the reflected part of the optical signal at the first inclined surface of the first optical fiber from causing total reflection within the first optical fiber.

15. The method for making a VOA in MEMS as described in claim 11, wherein the oblique angle of the first inclined surface prohibits the reflected part of the optical signal at the first inclined surface of the first optical fiber from causing total reflection within the first optical fiber.
